(19) United States
(12) Patent Application Publication
(10) Pub. No.: US 2018/0246886 A1
(43) Pub. Date: Aug. 30, 2018

(54) DATA MIGRATION FOR PLATFORM INTEGRATION

(71) Applicant: OSF Global Services Inc., Ville de Quebec (CA)

(72) Inventors: Cornelia Dragomirescu, BUCHAREST (RO); Gerard Szatvanyi, Ville de Quebec (CA); Anna Petriv, Wakefield, MA (US); Stefan Ioachim, BUCHAREST (RO); George Manolache, BUCHAREST (RO); Anca Comaneciu, Brasov (RO); Roxana Ivan, BUCHAREST (RO); Gabriel Ciobanu, BUCHAREST (RO); Marcel Blaga, BUCHAREST (RO); Alin Dorobantu, BUCHAREST (RO)

(73) Assignee: OSF Global Services Inc., Ville de Quebec (CA)

(21) Appl. No.: 15/905,388

(22) Filed: Feb. 26, 2018

Related U.S. Application Data
(60) Provisional application No. 62/464,194, filed on Feb. 27, 2017.

(51) Int. Cl. G06F 17/30

(52) U.S. Cl. CPC G06F 17/303; G06F 17/30377; G06F 17/30581

(57) ABSTRACT

A computer-implemented method including receiving an update event in a source database, the update event being associated with a user of the source database and a tenant of the source database, retrieving based on the update event, a set of updated data, the updated data being identified based on at least one indicator associated with the updated data, the indicator specifying when the updated data was last updated, processing the set of updated data to determine a set of relevant data for a target database, wherein at least a portion of the updated data can be not included in the set of relevant data, formatting the set of relevant data to generate formatted data that match a data configuration of the target database, and performing a migration session to transmit the formatted data to the target database.

### CROSS-REFERENCE TO RELATED APPLICATIONS

This application claims the benefit of U.S. Provisional Application Ser. No. 62/464,194, filed on Feb. 27, 2017, which is incorporated herein by reference in its entirety.

### TECHNICAL FIELD

The description relates to computer-implemented techniques for migration of data between platforms in a cloud-based multi-tenant environment.

### BACKGROUND

Advances in technologies have redefined collaboration methods between people using databases and related data processing systems used in commercial environments, e.g., those that facilitate pursuing business opportunities. Network-based processing systems are extensively used because they provide access to data and services via the Internet or other networks by making cooperative computing practical and manageable. In contrast to traditional systems that host networked applications on dedicated server hardware, a “cloud” computing model allows applications to be provided over the network “as a service” supplied by an infrastructure provider as a multi-tenant service platform. The increasing number of customers and tenants (e.g., business entities that use the platform) in addition to an increase in the number and complexity of cloud services can require the migration of data from one database to another database.

Migrations of data are typically performed during a service downtime period where at least a part of the service platform is taken offline while the migration of data is taking place. Depending on the amount of data to migrate, a migration of the data normally requires a considerable amount of time and results in excessive downtime for the service platform. Excessive downtime impacts tenants' ability to provide functional business applications and/or necessary data for use by customers.

### SUMMARY

The present disclosure relates to computer-implemented methods, computer-program products, and systems for migration of data between multi-tenant platforms. In one aspect, a computer-implemented method for data migration includes receiving, by the one or more processors, an update event in a source database, the update event being associated with a user of the source database and a tenant of the source database, retrieving, by the one or more processors, based on the update event, a set of updated data, the updated data being identified based on at least one indicator associated with the updated data, the indicator specifying when a portion of the updated data was last updated, processing, by the one or more processors, the set of updated data to determine a set of relevant data for a target database, wherein at least a portion of the updated data can be not included in the set of relevant data, formatting, by the one or more processors, the set of relevant data to generate formatted data that match a data configuration of the target database, and performing a migration session to transmit the formatted data to the target database.

Embodiments can include one or more of the following features. The indicator can include a first “last modified” field. Determining the relevant data can be carried out by using a second “last modified” field that can be updated based on knowledge of what data can be usable by the target database. The second “last modified” field can be updated based on flags associated with the data in the source database. The flags can be configured based on the characteristics of the target database known to the source database.

The characteristics of the target database can include one or more data processing applications associated with the target database. The processing can include determining flags indicating whether data can be currently being migrated or has been migrated. The flags can include a Boolean attribute of true or false. The source database and the target database can be multi-tenant databases that can be configured to be used by a plurality of tenants. The set of relevant data can include custom fields specific to the source database, wherein the custom fields can be not represented in the target database. The set of relevant data can include user profile data.

The user profile data can include text files containing a name, an address, a title, a city, and a state. The set of relevant data can include data associated with at least one of a service and an item provided by the tenant. The service can include at least one of storing and processing data. The item can include a merchandise available for purchase from the tenant by the customer.

The method can further include awaiting a trigger condition of one or more trigger conditions, at least one of the one or more trigger conditions including a real-time trigger condition. The trigger condition can include a status of an action, the action including a purchase order. The trigger condition can include a first trigger condition based on the number of data changes that occurred, and a second trigger condition based on a clock-based time schedule. The migration session can include reconciling the current state of data objects with corresponding data objects in the target database independent of a user action. The wherein formatting can be based on a mapping function. The update event occurs during an export of associated data from the source database to a target database.

In a general aspect, a non-transitory computer-readable storage medium coupled to one or more processors can have instructions stored thereon which, when executed by the one or more processors, cause the one or more processors to perform operations including: receiving, by the one or more processors, an update event in a source database, the update event being associated with a user of the source database and a tenant of the source database, retrieving, by the one or more processors, based on the update event, a set of updated data, the updated data being identified based on at least one indicator associated with the updated data, the indicator specifying when a portion of the updated data was last updated, processing, by the one or more processors, the set of updated data to determine a set of relevant data for a target database, wherein at least a portion of the updated data can be not included in the set of relevant data, formatting, by the one or more processors, the set of relevant data to generate formatted data that match a data configuration of the target database, and performing a migration session to transmit the formatted data to the target database.

In a general aspect, a system includes: a user interface module including a file manager configured to present a list of data objects to a user, a cross platform module configured to run the file management application on one of a plurality of operating systems, an authorization module configured to authenticate the user for access to a subset of a source database, an application protocol interface (API) toolkit configured to perform user-selected functions to update the data objects, and a migration engine configured to perform operations including: processing the updated data objects to determine a set of relevant data for a target database, formatting, by the one or more processors, the set of relevant data to generate formatted data that match a data configuration of the target database, and automatically synchronizing the formatted data with respective data in the target database.

Embodiments may include one or more of the following features. The user-selected functions include at least one of creating, deleting, and updating the data objects. The data objects can include text files containing customer information including name, address, title, city, and state. The user interface module can be further configured to display a migration file icon to an administrator, a merchant, or a second user. The migration engine can be configured to monitor files and directories in the subset of the source database and in the local computing device, and to reconcile updated files in real time.

The subject matter described in the specification can be implemented in particular implementations, so as to realize one or more of the following advantages. The implementations of the present disclosure include methods, computer-program products, and systems for migration of data between multi-tenant platforms. The data migration can include receiving an update event in a source database and transmitting updated data filtered based on relevance to a target database. The implementations of the present disclosure increase the efficiency of the data migration process and enhance a user's ability in interchangeably using both source and target databases by synchronizing relevant data between them. Selection of updated data for migration is based on format matching, which can effectively filter out updated data that is irrelevant for the target database. The format based filtering of updated data can improve corresponding data migration efficiency, while reducing computing resources by minimizing the amount of transmitted data during the migration process and increasing the speed of the migration process.

It is appreciated that methods in accordance with the present disclosure can include any combination of the aspects and features described herein. That is to say that methods in accordance with the present disclosure are not limited to the combinations of aspects and features specifically described herein, but also include any combination of the aspects and features provided. The details of one or more embodiments are set forth in the accompanying drawings and the description below. Other features and advantages will be apparent from the description, drawings, and claims.

### DESCRIPTION OF DRAWINGS

FIG. 1 is a block diagram illustrating an example system for migration of data.

FIG. 2 is a block diagram illustrating components of a migration manager.

FIG. 3 is a block diagram illustrating components of a service platform.

FIG. 4 is a flow chart of an example process of data access.

FIG. 5 is a flow chart of an example process of data migration.

FIG. 6 is a block diagram illustrating example computer systems that can be used to execute implementations of the present disclosure.

Like reference numbers and designations in the various drawings indicate like elements.

### DETAILED DESCRIPTION

This disclosure generally describes computer-implemented methods, computer-program products, and systems for automatically migrating data objects (e.g., files) between data processing systems. The data objects are created and updated within a source server and migrated from the source server to a target server. Typically, the source server and the target server can include multi-tenant databases that are configured to be used by a plurality of tenants (e.g., representations of entities who store data within the database, such that all of the data associated with one tenant is only available and used by the corresponding entity). As used herein, a “tenant” or an “organization” should be understood as referring to a group of one or more users that shares access to common subset of the data within a database. Sometimes, the source server is associated with one kind of data processing system that provides one set of functionality (e.g. cloud-based platform with applications for tenants, such as e-commerce merchants, developers and administrators, allowing the tenants to develop and manage custom digital commerce and mobile commerce sites). The target server can be associated with another kind of data processing system that provides another set of functionality (e.g., an interface for case management and task management, a system for automatically routing and escalating important events providing tenants the ability to track their own cases, a social networking capability that enables the tenants to join the conversation about their company on social networking websites, and/or analytical tools and other communication services) that can partially complement and/or can be at least partially different from the functionality of the source server. A real-world entity (such as a commercial enterprise) may wish to use both types of data processing systems, especially if the functionalities of the two system complements each other. If the same entity is using both systems (e.g., if the same entity is a tenant on both systems), data belonging to the entity can be identified as being relevant for both servers and may need to be synchronized between the two systems. For example, data of one system can be migrated to the other system.

One issue that may arise when migrating data is that not all data of one system is relevant to the other system, so the migration between the two systems can be managed by a migration process that takes into account the relevance of data that has been updated and makes an appropriate determination. In some implementations, the relevance of data can be determined based on information indicating which data is usable by (e.g., relevant to) one or more applications of the target server. Put another way, the source system can be modified in a way that accommodates characteristics of the target system. For example, the source system can be modified based on applications of the target system that will use data being migrated. In some examples, information indicating usable data can be provided by an index or a table configured to map data types to application types.

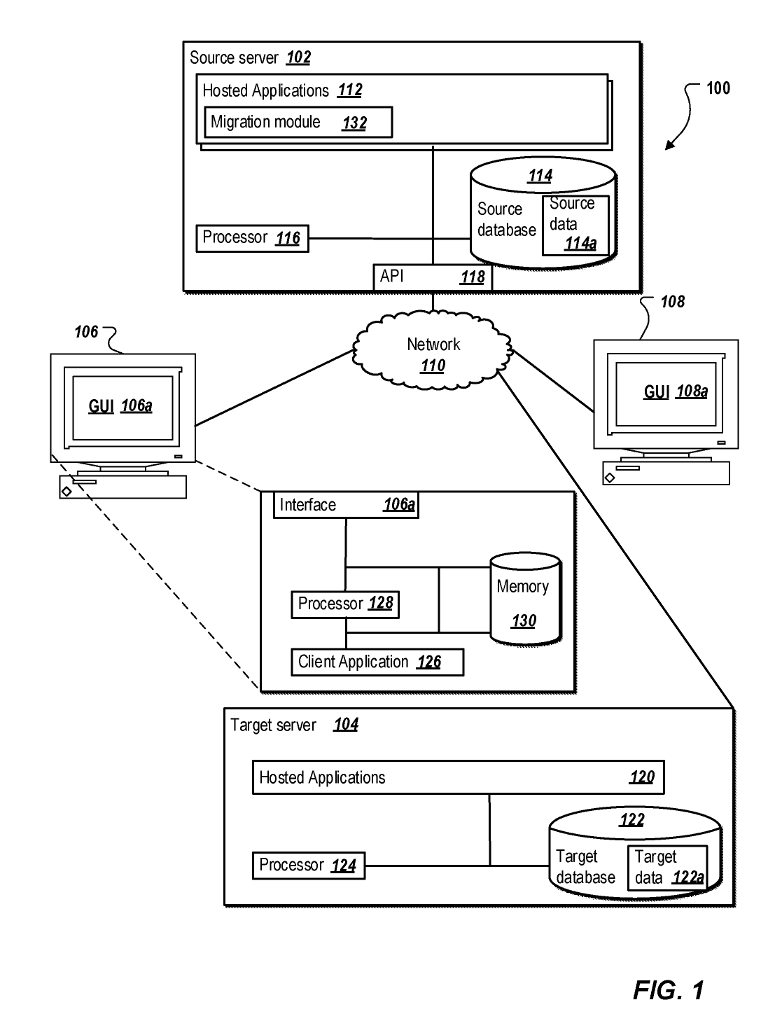

FIG. 1 illustrates an example distributed computing system 100 for migration of data objects. At a high level, the illustrated example distributed computing system 100 includes or is communicably coupled with a source server 102, a target server 104, a client device 106 (e.g., a customer's device), and a client device 108 (e.g., a tenant's device) that can communicate using, for example, a network 110 or other communication methods. In some implementations, the source server 102 and the target server 104 can each include a computer operable to receive, transmit, process, store, or manage data and information associated with the example distributed computing system 100 or be implemented on a single computer or multiple computers in various combinations. For example, the source server 102 may include many physical computer servers, as might the target server 104.

The source server 102 can include applications 112, a source database 114 storing source data 114a, a processor 116, an API 118, and a migration module 132 that is configured to process and transmit the source data 114a to the target server 104 during a migration process. The target server 104 can include applications 120, a target database 122 storing target data 122a, and a processor 124. The source server 102 and the target server 104 can each dynamically create and support applications 112, 120 based upon data from a corresponding database 114, 122, respectively. For example, the applications 112 of the source server can be different or partly different from applications 120 of the target server. Applications 112 can be configured to use source data 114a from the source database 114 that has a particular format type. Applications 120 can be configured to use target data 122a that has a different format than the source data 114a. The source database 114 and the target database 122 can be shared between multiple tenants, being referred to herein as a multi-tenant database. Data 114a, 122a and services generated by the applications 112, 120 can be provided via the network 110 to any number of client devices 106, 108. Applications 112, 120 can provide secure access to source data 114a in the source database 114 and target data 122a in the target database 122, respectively for each of the various tenants subscribing to the source server 102 or the target server 104.

In some implementations, the source server 102 and the target server 104 can be implemented in the form of an on-demand multi-tenant customer relationship management (CRM) system that can support any number of authenticated users (e.g., client devices 106) and multiple tenants (e.g., client devices 108). Each tenant (e.g., client device 108) can include one or more users (e.g., client device 106) associated with, assigned to, or otherwise belonging to that respective tenant. Stated another way, each respective user (e.g., client device 106) within the system 100 is associated with, assigned to, or otherwise belongs to a particular one of the plurality of tenants supported by the source server 102 or the target server 104. Tenants can represent companies, corporate departments, business or legal organizations, and/or any other entities that maintain data for particular sets of users (such as their respective customers) within the by the source server 102 and/or the target server 104. Although multiple tenants can share access to the source server 102 and/or the target server 104, the particular data and services provided by the source server 102 and/or the target server 104 to each tenant can be securely isolated from those provided to other tenants. The multi-tenant architecture can allow different sets of users to share functionality and hardware resources without necessarily sharing any of the data belonging to or otherwise associated with other tenants. In some implementations, each of the users (e.g., client device 106) and the tenants (e.g., client device 108) can generate a data update event, including the creation, the modification, the addition or removal of a part or a complete data object that is stored in the source database 114 and the target database 122.

The source database 114 and the target database 122 can be repositories or other data storage systems capable of storing and managing the data associated with any number of tenants. The source database 114 and the target database 122 can be implemented using conventional database server hardware. In some implementations, the source database 114 and the target database 122 can share processing hardware with the source server 102 and the target server 104, respectively. In some implementations, the source database 114 and the target database 122 can be implemented using separate physical and/or virtual (e.g., federated) database server (e.g., a container for components used to integrate data from multiple data sources, so that the multiple data sources can be accessed in an integrated manner through a single, uniform API 118 to view and query several databases as if they were a single entity) that communicates with the source server 102 and the target server 104, respectively to perform various functions described herein. The source database 114 and the target database 122 can alternatively be referred to as an on-demand database, in that the source database 114 and the target database 122 can provide (or is available to provide) data at run-time to on-demand virtual applications 112, 120, respectively.

In practice, the source data 114a and target data 122a can be organized and formatted differently, according to one or more requirements and characteristics of the source server 102 and the target server 104, respectively and/or applications 112, 120, respectively. In some implementations, the source data 114a and target data 122a can be formatted as multi-dimensional tables, including multiple fields. In some implementations, the source data 114a and target data 122a can be updated and formatted using a variety of metadata constructs. Metadata can be used to describe any number of forms, reports, workflows, user access privileges, business logic and other constructs that are common to multiple tenants. Metadata can include one or more indicators that describe operations performed on data. An example of an indicator can include a pointer to a field of the data that was “last modified.”

Tenant-specific formatting, functions and other constructs can be maintained as tenant-specific metadata for each tenant, as desired. As a result, the data of one tenant may be structured in one way, while the data of another tenant may be structured another way. For example, rather than forcing the source data 114a and target data 122a into an inflexible global structure that is common to all tenants and applications, the source database 114 and the target database 122 can be organized to be relatively amorphous, with the tables and the metadata providing additional structure on an as-needed basis. These potential differences in structure can be taken into account when migrating data from the source server 102 to the target server 104. The source server 102 and the target server 104 can use the tables and/or the metadata to generate “virtual” components of the applications 112, 120, respectively to logically obtain, process, and present the relatively amorphous source data 114a and target data 122a from the source database 114 and the target database 122, respectively.

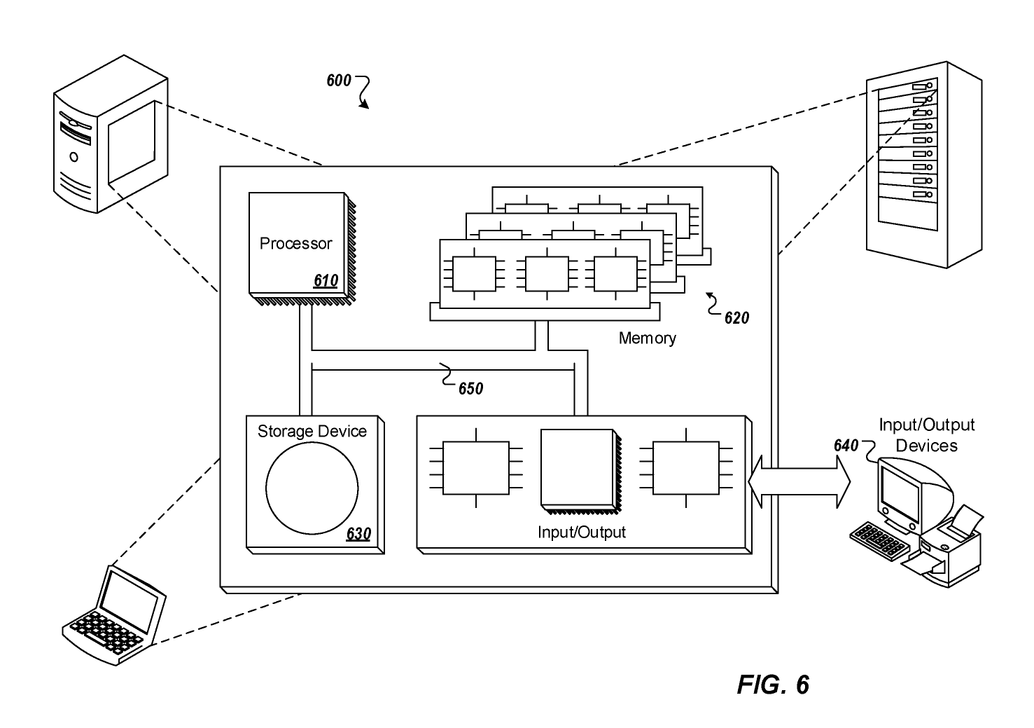

The source server 102 and the target server 104 can be implemented using one or more actual and/or virtual computing systems that collectively provide a dynamic application platform for generating the applications 112, 120, respectively. For example, the source server 102 and the target server 104 can be implemented using a cluster of actual and/or virtual servers operating in conjunction with each other, typically in association with conventional network communications, cluster management, load balancing and other features as appropriate. The source server 102 and the target server 104 can operate with any sort of conventional processing hardware, such as processors 116 and 124, respectively, memory, input/output features and other relevant components, as described in detail with respect to FIG. 6.

The applications 112, 120 can include any sort of software applications or other data processing algorithms that that provide data and/or services to the client devices 106, 108. The applications 112, 120 can be generated at run-time in response to an input received from the client devices 106, 108. The applications 112, 120 can be constructed in accordance with the tenant-specific metadata, which describes the particular tables, reports, interfaces and/or other features. In some implementations, applications 112, 120 can generates dynamic web content that can be served to a browser or other client program associated with client devices 106, 108, as appropriate.

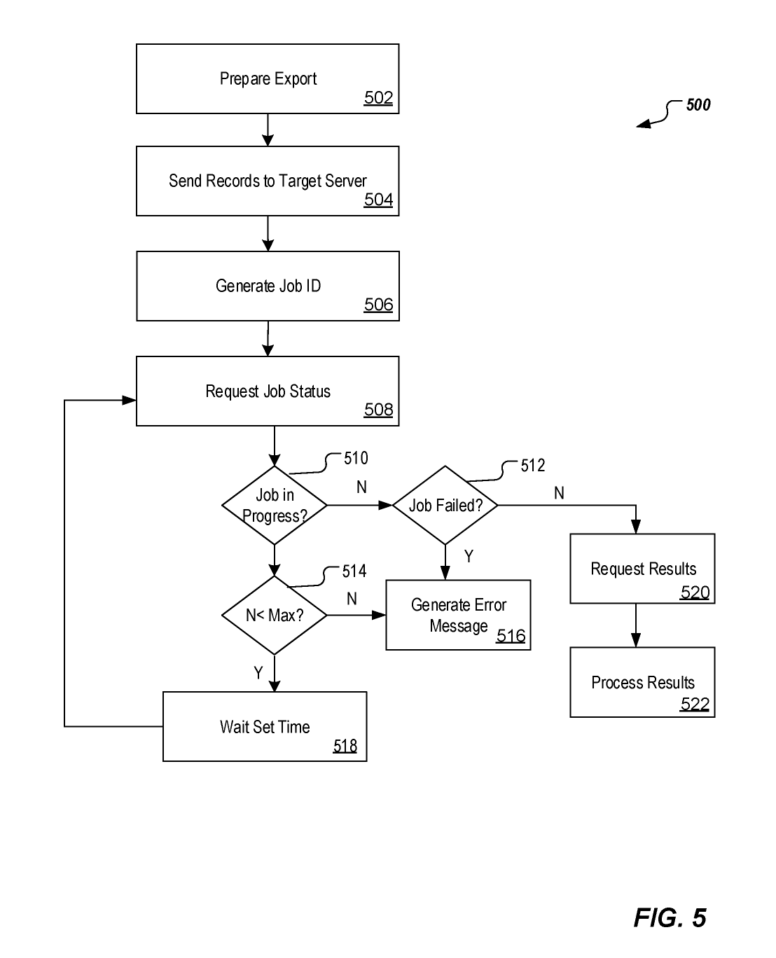

The applications 112, 120 can make use of an application protocol interface (API) 118, interface features such as custom (or tenant-specific) user interfaces 106a, 108a, standard (or universal) user interfaces or the like. The API 118 can be configured to facilitate various interactive functions between the local computing device and the multi-tenant environment such as, for example, the creation, deletion, updating, retrieval, searching, sorting, and reporting of files and other data objects. The API 118 can be configured to transfer a large number of records between the source server and the target server by using a minimum amount of API calls that can be limited to a set number (e.g., 5000 API calls/day). In some implementations, the API 118 includes a bulk API wrapper, configured to insert, update, and delete large numbers of data asynchronously by submitting them in batches to the target server, according to the process described with reference to FIG. 5.

Any number of custom and/or standard source and target data objects 114a, 122a can be available for creation and update using applications 112, 120, respectively. As used herein, “custom” should be understood as meaning that a respective data object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The source data 114a and target data 122a associated with applications 112, 120 are provided to the source database 114 and the target database 122, as appropriate, and stored along with the metadata that describes the particular features (e.g., reports, tables, functions, objects, fields, formulas, code, etc.) of that particular applications 112, 120. For example, multiple source data 114a and/or target data 122a is accessible to a tenant and can be processed by applications 112, 120, respectively using formatting information stored as metadata. The metadata can define the structure (e.g., the formatting, functions and other constructs) of each respective data object in the source database 114 and the target database 122 and the various fields associated therewith.

The data and services provided by the source server 102 and the target server 104 can be retrieved using any sort of personal computer, portable device, mobile telephone, tablet or other network-enabled client devices 106, 108 over the network 110. The client devices 106, 108 can include a display device, such as a monitor, screen, or another conventional electronic display capable of graphically presenting data and/or information retrieved from the source database 114 and the target database 122, within a graphical user interface (GUI) 106a, 108a corresponding to a client application 126. The client devices 106, 108 can also include a processor 128 and a memory 130. In some implementations, memory 130 can act as a cache and/or storage location for source data 114a or target data 122a. Although illustrated as a single memory 130 in FIG. 1, two or more memories 130 can be used according to particular requirements of a commercial entity or particular implementations of the example distributed computing system 100.

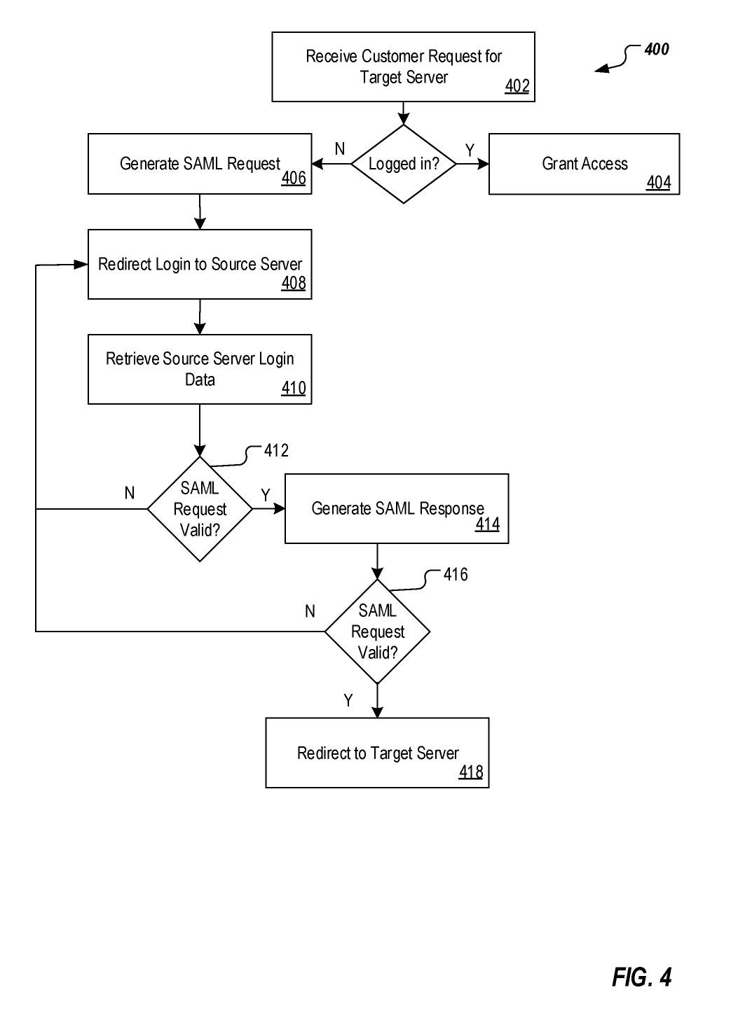

A user of a client device 106 can access a conventional browser application or an interface 106a to contact the source server 102 and the target server 104 over the network 110 using a networking protocol, such as the hypertext transport protocol (HTTP) or the like. The user can provide authentication information to the source server 102 or the target server 104 to requests access to one or more of applications 112 and/or 120, as described in detail with reference to FIG. 4.

In some implementations, applications 112, 120 can contain Java, ActiveX, or other content that can be presented using conventional client software running on the client devices 106, 108. In some implementations, applications 112, 120 can provide dynamic web or other content that can be presented and viewed by the user, as desired. Applications 112, 120 can include a functionality that allows a user to update source data 114a and target data 122a, respectively locally on the client device, and automatically synchronize the updated data with the source database 114 and the target database 122, respectively. Data migration can be performed automatically without requiring the user of the client device 106 or 108 to separately open up a browser, access the source database 114 or the target database 122 through a dedicated web interface, and manually upload each new file to the multi-tenant source database 114 or the target database 122. For example, the user can create, delete, and revise files locally, and synchronize the files with the multi-tenant database without having to separately log into the web-based portal. Conversely, files added to or updated in the source database 114 or the target database 122 using the traditional web-based interface can be automatically synchronized to the client device 106, 108.

In some implementations, a portion of the applications 112 that are accessible through the source server 102 correspond to a portion of the applications 120 that are accessible through the target server 104. The corresponding portion of applications 120 can use data 122a that can correspond to a portion of data 114a stored within the source database 114 (e.g., relevant data). The migration module 132 can be configured to monitor data elements within files and directories stored in the source database 114 and in the local computing device, and to reconcile (e.g., by making data in target database consistent with data in source database) updated data elements in real time by filtering data 114a, extracting relevant data, formatting relevant data and transmitting formatted data to the target database 122. In some implementations, data 114a stored within the source database 114 and data 122a stored within the target database 122 include different formats. The migration module 132 can be configured to format the relevant data to match the format of target data 122a. The migration module 132 can be configured to migrate the formatted data to the target database 122 over the network 110.

The migration module 132 can be configured to detect the creation or the update of source data 114a in the source database 114 and to generate an update event that can automatically prepare (e.g., filter and format) the updated source data 114a for transmission to the target database 122. In some implementations, requests to migrate data can also be received from either of the client devices 106,108, internal users, external or third-party customers, other automated applications, as well as any other appropriate entities, individuals, systems, or computers. The migration module 132 can include or be communicably coupled with an e-mail server, a web server, a caching server, a streaming data server, and/or other suitable server. In some implementations, the migration module 132 and related functionality can be provided in a cloud-computing environment.

The migration module 132 can be connected to the interface 106a, a processor 128, and memory 130. The interface 106a can be used by the migration module 132 for communicating with other systems in the example distributed computing system 100, for example the client device 106. Although illustrated as a single interface 106a in FIG. 1, two or more interfaces can be used according to particular requirements of a commercial entity, or particular implementations of the example distributed computing system 100. Generally, the interface 106a includes logic encoded in software and/or hardware in a suitable combination and operable to communicate with the network 110. More specifically, the interface 106a can include software supporting one or more communication protocols associated with communications such that the network 110 or the interface 106a hardware is operable to communicate physical signals within and outside of the illustrated example distributed computing system 100.

The processors 116 and/or 128 can be used by the migration module 132 to receive/respond to requests, execute instructions, and/or manipulate data to perform operations specific to the migration module 132. Specifically, the processor 116 or 128 executes the functionality required to migrate the updated source data 114a to the target database 122. In some implementations, the migration module 132 can execute a single instance, and/or a plurality of migration functions. The migration module 132 can be a service or stand-alone application that converts updated source data 114a from a format supported by the source database 114 into a format usable by the target database 122. In some implementations, the migration is triggered by a data update, as discussed above. In some implementations, the migration module 132 automatically determines that a migration of source data 114a is required, while in others, the migration can be triggered by manual user actions, as described in detail with reference to FIG. 5.

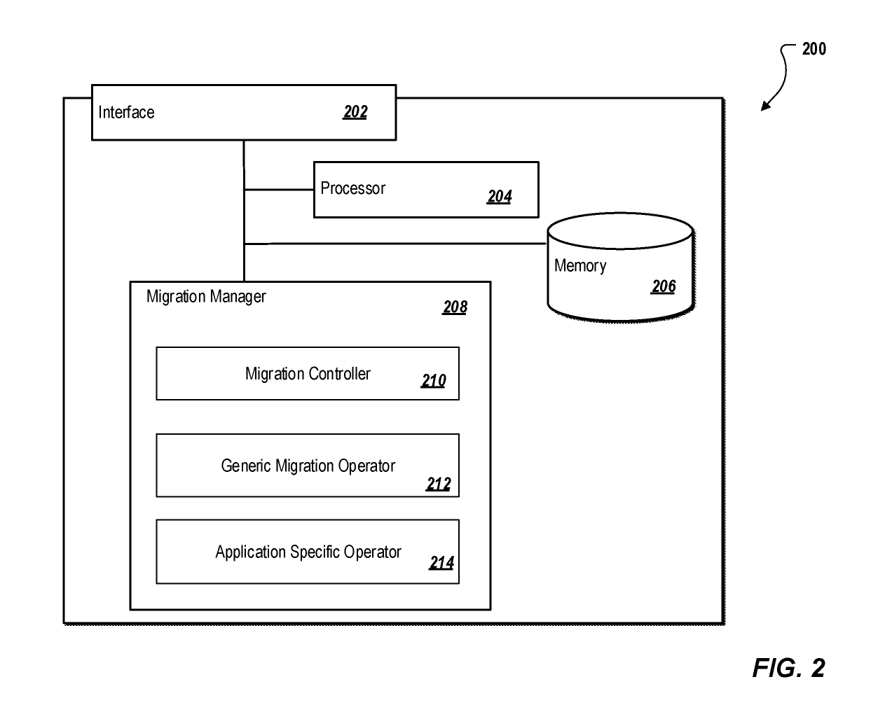

FIG. 2 illustrates a block diagram illustrating components of an example of a migration module 200 (e.g., migration module 132 described with reference to FIG. 1). The migration module 200 provides, among other things, overall control/management of the data migration process, handling of data creation and data updates, confirmation of data migration success, and logging of data migration results. The migration module 200 can include an interface 202, a processor 204, a memory 206 and a migration manager (MM) 208. The MM 208 can include a migration controller (MC) 210, a generic migration operator (GMO) 212, and an application-specific operator (ASO) 214. The MM 208 is implemented in a mainly application-independent/generic manner, by which we mean that the MM 208 is largely independent of application-specific knowledge apart from necessary application-specific migration knowledge and/or logic provided by the ASO 214.

The MC 210 provides, as stated above, the overall control/management of the data migration process, including coordinating other components of the MM 208, and handles concurrent data updates running on the source server to provide a seamless or near-seamless handling of data migration (e.g., by migrating data immediately after a trigger condition appears, such as an identification of data creation or data update without an hours or days long delay). The MC 210 does not delay any services provided by the source server accessing the same data in parallel to a migration of the MM 208. The MC 210 also ensures any data which has been accessed and updated by a concurrent application during migration will be migrated again in order to achieve final data consistency. The migration manager also confirms that data is successfully migrated and performs data migration process logging functions. Exception handling is also performed by the MC 210. For example, the migration manager can manage migration process restarts in the case of migration process interruptions and/or process failures.

To migrate data, the GMO 212 uses a meta-model (described below) to transform data from a source model format to a target model format. In some implementations, during data migration, the GMO 212 updates a shadow database with the source data in the target model format. The GMO 212 provides knowledge and/or logic to migrate data.

The ASO 214 provides application-specific migration knowledge and/or logic needed for migration that is not contained in the meta-model of GMO 212. For example, there may be entries in a dependent database table belonging to a particular instance of an application. If the dependency is not fully described in the meta-model, the ASO 214 provides the logic to determine the identifier for the instance corresponding to the entries. In some implementations, a reference to the ASO 214 may be provided for the MM 208 to access and execute as needed. The ASO 214 generally requires little development and/or test effort to prepare for a migration process from a source server to a target server.

In some implementations, the MC 210, GMO 212, and/or ASO 214 can be implemented as class libraries written in suitable computer languages. The class libraries provide interfaces. The class libraries can be imported by the source server into a source database, stored in specific shadow tables containing code for data migration. The MES 102/MM 208 can access the migration code directly from the source database using specific aliases in the shadow database schema.

The ASO 214 can be configured to keep track of data necessary to be migrated (e.g., relevant newly updated or created data) that is associated with a particular application within the target server. For example, the migration manager can migrate all data elements associated with a particular set of target data element types identified in a mapping table as being in a 1:1 correspondence. The GMO 212 may work in conjunction with the ASO 214 to provide various tasks. For example, during migration of each data element, an identifier of the data element can be stored for each database record belonging to the instance for all database tables of the source data model. This is needed to identify data elements that need to be re-migrated in a later migration phase due to data updates during migration process. Further, instance identifiers may be different between data models corresponding to different applications of the target server. For this reason, a mapping from the source to target identifiers must be kept because other instances which are migrated at a later point in time may have references for instances which are already migrated. These references must be adapted to the new identifiers during migration.

In addition, if a data element is changed, this does not necessarily mean that all database records associated with the changed data element are changed. For example, one element of a customer's contact data (e.g., mailing address) has changed and as a result only one row in one dependent database table is updated while other data elements (e.g., customer's phone number) in the source database table remains unchanged. From the database triggers, only the key of the changed row in the dependent database table is known and retrieved by the MC 210. The GMO 212 and/or ASO 214 determine the value of the data element that the row in the dependent database table belongs to.

Logic is also provided to determine the need for re-migration between database tables and corresponding shadow database tables. For example, the MC 210 can determine instances which need to be re-migrated in one or more later migration phases due to data changes by parallel operating business applications. The ASO 214 may also define a minimal required specific logic which cannot be implemented centrally using corresponding interfaces. For example, given field values of “Last Modified,” “Previously Modified,” and “Newly Created” the mapping between source and target data fields could be modeled to automatically migrate specific data elements, as described with reference to FIGS. 4 and 5.

Although illustrated in FIGS. 1 and 2 as a single migration module 132 or 200, two or more migration modules may be used according to particular requirements, or particular implementations of example distributed computing system 100. For example, a migration module 132 may be executed on the source server 102 and/or the target server 104. The migration module 132 or 200 can be any application, program, module, process, or other software that may provide methods and a graphical user interface to evaluate, transform, create, store, delete, and/or other suitable operation required to migrate data from a source format into a target format. In some implementations, a particular migration module 132 or 200 can operate in response to and in connection with at least one data creation or data update, associated to an application executed on the source server 102. In some implementations, each migration module 132 or 200 can represent a web-based application accessed and executed by remote client devices 106, 108 using the network 110 (e.g., through the Internet, or using at least one cloud-based service associated with the MM 208). For example, a portion of a particular migration module 132 or 200 may be a web service associated with a migration module 132 or 200 that is remotely called, while another portion of the particular migration module 132 or 200 may be an interface object or agent bundled for processing at a remote client device 106 or 108. Moreover, any or all of a particular migration module 132 or 200 may be a child or sub-module of another software module or enterprise application (not illustrated) without departing from the scope of this disclosure. Still further, portions of the particular migration module 132 or 200 may be executed or accessed by a user working directly at the client device 106 or 108 and/or source database 114.

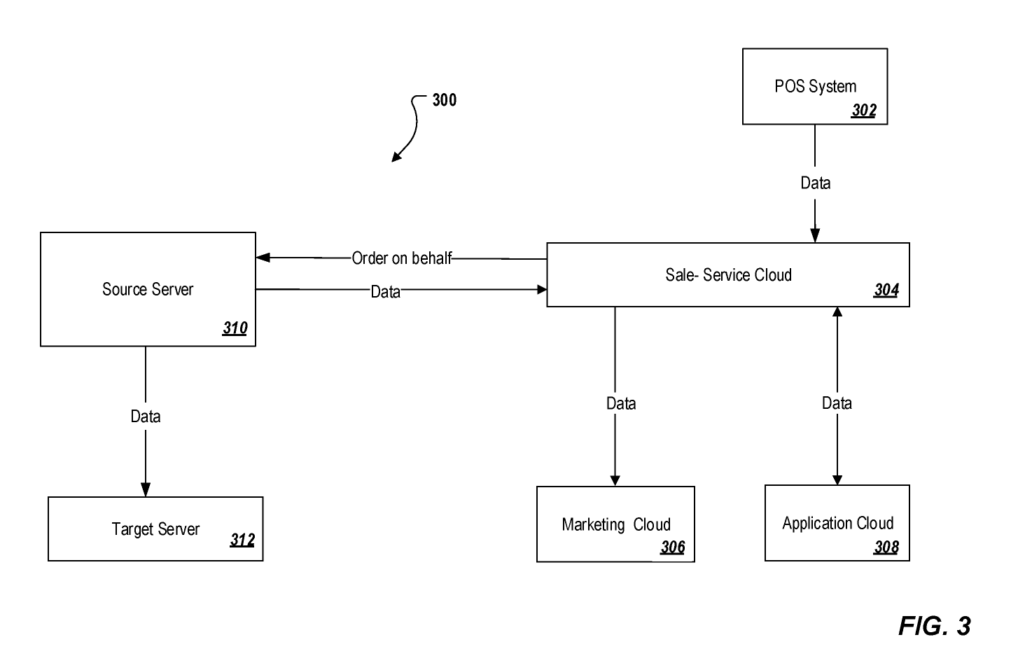

FIG. 3 illustrates a block diagram including components of an example of a connected server 300. The example connected server 300 can include multiple platforms configured to share data between each other. In some implementations, the example connected server 300 can include a point of sale (POS) system 302, a sale-service cloud 304, a marketing cloud 306, an application cloud 308, a source server 310, and a target server 312. In some implementations, each platform of the connected server 300 can enable a user to generate and/or update data that can be migrated from the source server 310 to the target server 312, as described with reference to FIGS. 4 and 5.

The POS system 302 can include a plurality of physical stores with associated computing devices, configured to provide to a plurality of customers services corresponding to the connected server 300. The source server 310 can include a cloud-based service for unifying the way tenants engage with customers over a network connecting multiple devices. In some implementations, POS system 302 and the source server 310 can be configured to add, modify and/or delete customers associated with one or more tenants of the connected server 300. The POS system 302 and the source server 310 can be configured to add, modify and/or delete newly generated, pending and/or submitted orders associated to the customers. The POS system 302 can transmit data associated to the customers and the orders to the sale-service cloud 304, such that data coming from physical stores located in a variety of places. The source server 310 can transmit data associated to the customers and the orders to the sale-service cloud 304, such that data coming from virtual online stores. The data generated through online stores can include customer information, orders, abandoned carts, wish lists, reviews and other customer and tenant related data. The sale-service cloud 304 can be configured to centralize data received from POS system 302 and source server 310 at one place. In some implementations, the POS system 302 and the source server 310 can transmit data to the sale-service cloud 304 using a source server connector. The source server connector can be configured to sync customer and order information between POS system 302, the source server 310 and sale-service cloud 304. In some implementations, the sale-service cloud 304 can include a key performance indicator (KPI) panel to display an order history (e.g., online order and/or in-store orders), using multiple available metrics through POS system 302 and the source server 310. The KPI panel can be used to determine customer's buying patterns and can provide recommendations and services to the customers. In some implementations, the source server 310 can include one or more custom user interface frameworks (e.g., lightning component framework) for developing dynamic web applications for mobile and desktop devices. Within the context example, the user interface frameworks can be configured to enable a customer or a tenant to contextualize a shopping experience. In some implementations, the source server 310 can include a customer service functionality. The customer service functionality can provide tenants with full visibility over all customers' orders and/or comments submitted within the source server 310. The customer service functionality can enable tenants to respond to customer requests and to offer technical support associated to the products and services provides, to make product recommendations based on a customer's profile, and place orders on the customers' behalf.

The sale-service cloud 304 can be configured to provide a unified view of the customers including online and offline order activities performed on the source server 310. The data transmitted from source server 310 to sale-service cloud 304 can be used for sale activities. For example, sale customers can generate and update their customer profiles and view customer key parameter indices. The customer key parameter indices can include data such as date since being a customer, order count, order amount, and in store/online orders. The customers and the tenants can use opportunity data for sale cycle management, forecasting orders, tracking orders, and managing orders. Source server can provide functionalities of “order on behalf” for sales/service representatives, through which representatives can switch between source server 310 and sale-service cloud 304 for placing orders on behalf of customers. Using the data available, such as orders and customer information, service representatives can provide responses to customer queries and complaints on sale-service cloud 304, the responses including new or updated data associated to the customers.

The sale-service cloud 304 can transmit data to the marketing cloud 306. In some implementations, the connected server 300 can utilize a native marketing cloud connector for synchronizing data between the sale-service cloud 304 and the marketing cloud 306. The marketing cloud 306 can use the data to design campaigns targeted to specific marketing activities, to segment the customer data based on profiles, purchasing history, interest or other data characteristics.

The sale-service cloud 304 can share data with (e.g., transmit data to and receive data from) the application cloud 308 using a connector. The application cloud 308 can include a platform configured to utilize customer data, such as orders, customer information and recommended products received from the sale-service cloud 304. A representative (e.g., a user of the sale-service cloud 304) can use customer data available on the application cloud 308 to provide a unique and personalized experience to the customers. For example, a store representative can have access to read and update the corresponding customer data and purchasing history, such as email address, mailing address or anniversary. Store representatives can be enabled to generate new data, such as by collecting feedback from the customers. Newly generated data can be processed by the application cloud 308 or the sale-service cloud 304 to analyze and improve the customers' experience.

The sale-service cloud 304 can communicate (e.g., transfer data) over the source server 310 with the target server 312. The target server 312 can include an online social platform that enables tenants to connect customers, partners, and employees with each other and the data and records they require to accomplish a task. The target server 312 can provide a real-time collaboration between tenants and customers with the ability to share data between multiple devices connected to the connected server 300 and a target server.

The target server 312 can be configured to enable tenants to streamline key business processes and extend them across offices and departments, and outward to customers and other tenants. The data transparency offered by the target server 312 can enable tenants to service customers in real time and to effectively accomplish goals by migrating relevant data between the connected server 300 and a target server.

The connected server 300 connects the source server 310 with target server 312 to provide a customized shopping experience for customers. For example, by using single sign on (e.g., a single authentication to access multiple components of the source server), a customer can seamlessly navigate between source server 310 and target server 312 without being required to provide authentication data multiple times. Users can participate in a discussion about products or services by accessing the target server 312 to take informed decisions or to clarify any doubts they have before or after buying product or services while accessing the source server 310. While a customer navigates from the source server 310 to the target server 312, a persistent shopping cart lightning component of the connected server 300 can ensure that the customer's cart/basket remains intact and added products are available for checkout. Data from target server 312 and the source server 310 can be transmitted to the sales and service cloud 304 to generate additional data to be provided to the customers. For example, based on customer's interest, questions or discussions, in which a customer has participated or shown interest in while being in the target server 312 and/or the source server 310 a recommended list of products, services, and tenants can be identified and sent to the customer. The connected server 300 can be configured to provide migration of at least a portion of the data generated by any component of the connected server 300 to a target server, as described with reference to FIGS. 4 and 5.

FIG. 4 is a flow chart illustrating an example of a method 400 for accessing data through a source server and a target server using a single-sign on functionality that is available in response to data migration from the source server to the target server. For clarity of presentation, the description that follows generally describes method 400 in the context of FIGS. 1, 2, and 3. However, it will be understood that method 400 may be performed, for example, by any other suitable system, environment, software, and hardware, or a combination of systems, environments, software, and hardware as appropriate.

At 402, a customer's request to access a target server is received. The customer's request can include authentication data (e.g., user ID and password) that correspond to a customer's account within the target server or the source server. The target server can include an authorization module configured to process the authentication data. At 404, if the authentication process is successful for the target server (e.g., the customer's authentication data matches a customer's account within the target server), the customer is granted access. At 406, if the authentication data does not match any customer account within the target server, a request to exchange authentication and authorization data between the target server and the source server is generated. In some implementations the exchange authentication and authorization request includes a security assertion markup language (SAML) request, which is an)(MIL-based, open-standard data format for exchanging authentication and authorization data between parties, in particular, between the target server and the source server.

At 408, in response to the exchange authentication and authorization request, the authentication request is redirected to the source server. At 410, the source server can include an authorization module configured to receive and process the authentication data. At 412, if the authentication is successful, the authentication and authorization request is determined as being valid. At 416, in response to a valid authentication, a response is generated by the source server, at 414 and transmitted to the target server. At 412, if the authentication is not successful, the authentication and authorization request is determined as being invalid. At 416, in response to determining that the authorization request is invalid, an indication of an invalid request is transmitted to the target server. In some implementations, one or more of the steps of method 400 can be repeated multiple times. For example, if a customer provides an incorrect user ID or an incorrect password, the customer may be allowed to retry providing the correct authentication data a number of times, that could be limited to a particular threshold to prevent unauthorized user access. In some implementations, steps 406 to 416 are performed automatically (e.g., without requiring a customer's input to redirect the authentication process to the source server). In some implementations, a customer is authenticated once and within a login session can successively access the target server and the source server. While accessing the source server, the customer can generate new data and can update at least a portion of existent data. Relevant newly generated and updated data can be migrated from the source server to the target server, as described with reference to FIG. 5. Relevance based selection of a portion of the updated data that is less than the total amount of updated data minimizes computer and system resources necessary for migration, while increasing the efficiency and the speed of the migration process.

FIG. 5 illustrates an example process 500 of data migration between the source server and the target server. For clarity of presentation, the description that follows generally describes process 500 in the context of FIGS. 1, 2, and 3. However, it will be understood that process 500 may be performed, for example, by any other suitable system, environment, software, and hardware, or a combination of systems, environments, software, and hardware as appropriate. In some implementations, the process 500 is initiated in response to receiving a trigger condition. For example, the process 500 can include awaiting a trigger condition of one or more trigger conditions, at least one of the one or more trigger conditions including a real-time trigger condition (e.g., the trigger condition is generated substantially simultaneously with a detection of a data creation and/or data update event). In some implementations, the trigger condition can include a status of an action, such as a purchase order. In some implementations, the trigger condition can include a first trigger condition based on the number of data changes that occurred and a second trigger condition based on a clock-based time schedule.

At 502, a migration of data is prepared at the source server. Preparing data can include identifying each element of the data to be exported by detecting an update event in the source database, e.g., without requiring manual transfer of the data or interruption of services provided by either the source database or the target database. In some implementations, the update event can be associated with users (e.g., customers and/or tenants), who have accounts in both a source server and a target server that can be matched based on one of a user authentication, identification or contact data. For example, for users who have accounts on both the source server and the target server, data elements associated to business data (e.g., orders, services and/or products) can be migrated from the source database to the target database. In some implementations, the update event can be associated with a user who has an account at least in a source server. For example, for users who have accounts only on the source server, data elements migrated from the source database to the target database includes personal data, such as a user authentication, a user identification, user contact data and, optionally, business data. The personal data can be user profile data that includes text files containing a name, an address, a title, a city, and a state. The update event can include a data element of the source database that is created or updated (e.g., modify, add or delete) by a user. For example, knowing that the target system might request information about removed products from an order (e.g., a shopping basket) the source system can be adapted to track associated actions and items, making the associated actions (e.g., removal from basket) and items (e.g., removed items) available for migration to the target system. Preparing the data elements to be migrated can include a serialization of data according to a particular sequence of combining personal data and business data.

The data elements including personal data and business data that are to be migrated can be identified based on “flags” and “hooks,” the flags being identifiers of an action occurrence and hooks being indicators of different actions (e.g., creation, removal or update dates and times). One hook can correspond to a “last modified” field indicating a date and time of the most recent update of a particular data element. For example, if a first name of a user (e.g., customer or tenant) of a source system changes a hook is added to indicate that an event (e.g., changing a name event) has occurred and in response, an associated data set (e.g., user profile) is marked to be migrated. The flags can be Boolean flags with an “on” or “off” state or can include a Boolean attribute of true or false. The flags can indicate whether the data element is a candidate for migration or not and whether a data element is currently being synchronized or has been synchronized. The flags can be specific to a configuration of a target system. For example, if the target system is associated with a set of executable applications (e.g., the applications are configured to manipulate data of a database of the target system), then the flags can be assigned based on characteristics of those executable applications. Put another way, the flags can be assigned based on whether or not an application is configured to use one or more elements of data if the data elements are migrated. Further, the flags chosen for one tenant's data may be different than the flags chosen for another tenant's data, if the applications used by the tenants on the target system are different. In some implementations, user data (e.g., user IDs, user current and past orders, user preferences, and/or user interests) are stored using a mapping function (e.g., key-value mapping method) and data tables (e.g., linear data tables).

In some implementations, only a part of the data elements that were created, updated and stored at the source database is relevant to (e.g., appropriate to migrate to) the target database. In some implementations, a data element is identified as being relevant if at least one application of the target server requires the data element for performing a function. For example, relevant data can include data associated with at least one of a service and/or an item (e.g., a product) provided by a tenant of the target server, the service including at least one of storing and processing data and the item including a merchandise item available for purchase. The relevant data can include custom fields (e.g., fields defined by a user of the source server to store the instance of any data type in metadata) specific to the source database, wherein the custom fields are not represented in the target database. The data elements associated to the update event can be filtered to extract relevant data for the target database. The relevant data can be determined by filtering out procedural information, such as an identifier of a last time the user logged in to a source platform that is associated with the source database. In some implementations, the relevant data is extracted using filtering criteria that is based on customer's preferences.

The relevant data can be formatted to match a data configuration of the target database using a mapping function. The mapping function defines the association between the objects and fields of the source system and objects and fields of the target system. In some implementations, the mapping function enables a user (e.g., a tenant and/or an administrator of the source system and/or target system) to use a graphical user interface to define, add, delete or modify associations between the objects and fields of the source system and objects and fields of the target system. For example, the user can use the graphical user interface to choose fields of the source system and associate each of them with fields of the target system.

In some implementations, the mapping function can include an automatic process to create a structure index associated to key values for the data in the source system and a process to generate a key function that calculates the change of the key value (e.g., key values increase and/or decrease) and triggers a migration from the source system to the target system. For example, mapping can include data-interchange formats defining data in a tree structure particular to a particular data-interchange format of the source system, such as a JavaScript Object Notation (JSON). Mapping can include a trigger for transmission and conversion of JSON data into a particular data structure (e.g., XML data structure) using a code. An example of a mapping function is illustrated below:

“customers”: {

“operation”: “upsert”,
“sobject”: “Account”,

“concurrency”: “Parallel”,
“externalField”: “OSF_DWback_{——}DW_ID_{——}c”,
“recordTypeId”: “01236000000sJ51”,

“fields”: {

“ex.externalField”: “OSF_DWback_{——}DW_ID_{——}c”,

“ex.recordTypeId”: “RecordTypeId”,
“ex.syncedFlag”: “OSF_DWback_{——}Modified_by_DW_{——}c”,
“firstName”: “FirstName”,

“lastName”: “LastName”,

“email”: “PersonEmail”,
“title”: “Salutation”,
“jobTitle”: “PersonTitle”,
“ex.birthday”: “PersonBirthDate”,
“phoneHome”: “PersonHomePhone”,

“phoneBusiness”: “PersonOtherPhone”,

“phoneMobile”: “PersonMobilePhone”,
“fax”: “Fax”,
“ex.customerGroup”:
“OSF_DWback_{——}Customer_Group_{——}c”,
“ex.street”: “BillingStreet”,

“addressBook.preferredAddress.phone”: “Phone”,

“addressBook.preferredAddress.city”: “BillingCity”,
“addressBook.preferredAddress.countryCode”:
“BillingCountry”,
“addressBook.preferredAddress.stateCode”: “BillingState”,
“addressBook.preferredAddress.postalCode”:
“BillingPostalCode”,

“customerNo”:
“OSF_DWback_{——}Demandware_Customer_Number_{——}c”}.

Corresponding data elements used by the source server and the target server can have different names and different properties. For example, field mapping of the source server and the target server can have different names, such that the field “FirstName” for “Profile” data element in the source database can correspond to “FirstName” for “Account” in the target database. In some implementations, semantic rules are applied to identify and match the formats of the data elements used by the source server and the target server. Then, the data can be formatted based on the identified matches.

At 504, formatted data can be transmitted from the source database to the target database during a migration (e.g., synchronization) session. The migration session can include reconciling the current state of data objects with corresponding data objects in the target database independent of a user action. The migration session can include an asynchronous process. The asynchronous process includes sending relevant formatted data to the target database using a bulk API call. In some implementations, a date and time at which the migration session started is recorded.

At 506, a job identifier is generated. In some implementations, the job identifier includes a numeric identifier that can be associated with the migration of a particular set of data elements. For instance, the job identifier can be a concatenation of a source server identifier (e.g., volume identifier and source host network address), destination identifier (e.g., destination volume identifier and destination host network address), and transfer space identifier network address. As another example, the job identifier can be generated by computing a hash of the source volume identifier and source host network address, destination volume identifier and host network address, and transfer space network address. The job identifier can be used to identify the migration process that will be instantiated or mapped to the process identifier of the migration process. The job identifier allows the state information of a migration process to resolve back to the corresponding job tasked to the migration process. The migration job can be instantiated with an initial state to reflect instantiation of the migration process. The migration status can be written directly into a migration log by a migration module or passed into the migration process to seed a state engine of the migration process. The migration process can be instantiated on the source server or on the target server, associated with the transfer space. The migration process can be instantiated with the parameters of the job. The migration process can also be instantiated with a reference (e.g., address, link, or pointer) to a location that hosts the parameters for the migration job. The migration process can access the parameters after being instantiated.

At 508, a job status is requested. In some implementations, determining a job status includes retrieving a migration log that is updated to identify the migration process with the job identifier. The migration process can be identified by a thread identifier, process identifier, host address, virtual machine identifier, etc. Any identifier used to identify the migration process can be mapped to the job identifier. The job status can include any of an initiated status, an in-progress status, and a completed (successful and failed) status. In some implementations, the job status is displayed to a user of the source server, such as an administrator, a tenant (e.g., a merchant) or a customer (e.g., a buyer).

At 510, it is determined whether the job is still in progress. At 512, in response to determining that the job is in progress, it is determined whether a number of interrogations is smaller than a maximum number of interrogations. At 514, in response to determining that the number of interrogations is smaller than a maximum number of interrogations the process 500 is suspended for a preset interval of time, after which the process 500 returns to step 508. In some implementations, a script language of the source server that is used to implement the migration to the target database does not include a wait function. The script language can include a feature to suspend a job at a particular step and restart it after a preset interval (e.g., 1-20 minutes) at the same step.

At 516, in response to determining that the number of interrogations is larger than the maximum number of interrogations, an error message is generated. At 518, in response to determining that the job is not in progress, it is determined whether the job has failed. At step 516, in response to determining that the job has failed, an error message is generated. At 520, in response to determining that the job was successful, migration results are requested from the target server and an end time of the migration session is retrieved. At 522, the migration results generated by the target server are being processed. The processing can include automatically comparing a date and time of last modified fields of data elements to the start and end time of the migration process and updating hooks and Boolean flags associated with data elements. For example, data elements that were created or updated before the migration process and were included in the set of migrated data can be marked as migrated. Data elements that were created or updated after the start of the migration process even if they were included in the set of migrated data can be marked as not migrated. Data elements that were created or updated after the end of the migration process can be marked as not migrated. In some implementations, one or more of the steps of process 500 can be repeated multiple times until all data elements of the source database that are relevant for the target database are successfully migrated.

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit. The storage device 630 is capable of providing mass storage for the system 600. In one implementation, the storage device 630 is a computer-readable medium. In various different implementations, the storage device 630 may be a floppy disk device, a hard disk device, an optical disk device, or a tape device. The input/output device 640 provides input/output operations for the system 600. In one implementation, the input/output device 640 includes a keyboard and/or pointing device. In another implementation, the input/output device 640 includes a display unit for displaying graphical user interfaces that enable a user to access data related to an item that is collected, stored and queried as described with reference to FIGS. 1-4.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

1. A computer-implemented method executed by one or more processors, the method comprising:
receiving, by the one or more processors, an update event in a source database, the update event being associated with a user of the source database and a tenant of the source database;
retrieving, by the one or more processors, based on the update event, a set of updated data, the updated data being identified based on at least one indicator associated with the updated data, the indicator specifying when the updated data was last updated;
processing, by the one or more processors, the set of updated data to determine a set of relevant data for a target database, wherein at least a portion of the updated data is not included in the set of relevant data;
formatting, by the one or more processors, the set of relevant data to generate formatted data that match a data configuration of the target database; and
performing a migration session to transmit the formatted data to the target database.

2. The method of claim 1, wherein the indicator comprises a first “last modified” field, and wherein determining the set of relevant data is carried out by using a second “last modified” field that is updated based on knowledge of what data is usable by the target database.

3. The method of claim 2, wherein the second “last modified” field is updated based on flags associated with the data in the source database, wherein the flags are configured based on characteristics of the target database known to the source database.

4. The method of claim 3, wherein the characteristics of the target database comprise one or more data processing applications associated with the target database.

5. The method of claim 1, wherein processing comprises determining flags indicating whether data is currently being migrated or has been migrated and the flags comprise a Boolean attribute of true or false.

6. The method of claim 1, wherein the source database and the target database are multi-tenant databases that are configured to be used by a plurality of tenants.

7. The method of claim 1, wherein the set of relevant data comprises custom fields specific to the source database, wherein the custom fields are not represented in the target database.

8. The method of claim 1, wherein the set of relevant data comprises user profile data.

9. The method of claim 9, wherein the user profile data comprises text files containing a name, an address, a title, a city, and a state.

10. The method of claim 1, wherein the set of relevant data comprises data associated with at least one of a service and an item provided by the tenant, the service comprising at least one of storing and processing data, the item comprising a merchandise available for purchase from the tenant by a customer.

11. The method of claim 1, further comprising awaiting a trigger condition of one or more trigger conditions, at least one of the one or more trigger conditions comprising a real-time trigger condition, the trigger condition comprising at least one of a status of an action comprising a purchase order and a first trigger condition based on the number of data changes that occurred, and a second trigger condition based on a clock-based time schedule.

12. The method of claim 1, wherein the migration session comprises reconciling the current state of data objects with corresponding data objects in the target database independent of a user action.

13. The method of claim 1, wherein formatting is based on a mapping function.

14. The method of claim 1, wherein the update event occurs during an export of associated data from the source database to the target database.

15. A non-transitory computer-readable storage medium coupled to one or more processors and having instructions stored thereon which, when executed by the one or more processors, cause the one or more processors to perform operations comprising:
receiving, by the one or more processors, an update event in a source database, the update event being associated with a user of the source database and a tenant of the source database;
retrieving, by the one or more processors, based on the update event, a set of updated data, the updated data being identified based on at least one indicator associated with the updated data, the indicator specifying when the updated data was last updated;
processing, by the one or more processors, the set of updated data to determine a set of relevant data for a target database, wherein at least a portion of the updated data is not included in the set of relevant data;
formatting, by the one or more processors, the set of relevant data to generate formatted data that match a data configuration of the target database; and
performing a migration session to transmit the formatted data to the target database.

16. A system comprising:
a user interface module comprising a file manager configured to present a list of data objects to a user;
a cross platform module configured to run a file management application on one of a plurality of operating systems;
an authorization module configured to authenticate the user for access to a subset of a source database;
an application protocol interface (API) toolkit configured to perform user-selected functions to update the data objects; and
a migration engine configured to perform operations comprising:
processing the updated data objects to determine a set of relevant data for a target database,
formatting the set of relevant data to generate formatted data that match a data configuration of the target database, and
automatically synchronizing the formatted data with respective data in the target database.

17. The system of claim 16, wherein the user-selected functions comprise at least one of creating, deleting, and updating the data objects, the data objects comprising text files containing customer information including name, address, title, city, and state.

18. The system of claim 16, wherein the user interface module is further configured to display a migration file icon to an administrator, a merchant, or a second user.

19. The system of claim 16, wherein the migration engine is configured to monitor files and directories in the subset of the source database and in the local computing device, and to reconcile updated files in real time.
